(19) United States
(12) Patent Application Publication
(10) Pub. No.: US 2003/0178388 A1
(43) Pub. Date: Sep. 25, 2003

(54) Inverted micro-vias

(76) Inventor: Kenneth L. Phillips, Placentia, CA (US)

Correspondence Address: LAWRENCE N. GINSBERG, ATTORNEY AT LAW, 907 CITRUS PLACE, NEWPORT BEACH, CA, 92660, US

(21) Appl. No.: 10/104,262

(22) Filed: Mar. 22, 2002

(51) Int. Cl. H01B 13/00

(52) U.S. Cl. 216/13

(57) ABSTRACT

A precursor component structure (and a method for forming the precursor component) for a printed circuit board (PCB). The precursor component structure includes a primary composite sheet having a primary upper foil sheet, a primary lower foil sheet and a primary dielectric sheet located therebetween. The primary composite sheet has a desired material set. The primary upper foil sheet is for ultimate use as an external layer of the PCB. The primary lower foil sheet has a primary micro-via hole formed therein that extends through the primary dielectric sheet to a lower surface of the primary upper foil. A primary electrically conductive layer is formed over surfaces of the primary dielectric sheet defining the primary micro-via hole. Thus, a primary electrically conductive path is formed from the primary upper foil sheet to the primary lower foil sheet using these “inverted micro-vias”.

### BACKGROUND OF THE INVENTION

1. Field of the Invention

The present invention relates to printed circuit board (PCB) fabrication and, more particularly, to the enhanced utilization of micro-vias for increasing the functionality of a PCB.

2. Description of the Related Art

There is a continuing need to reduce the size of surface mounted components within PCB's. Utilization of high density interconnects enhances the functionality matching between the PCB and the components within the PCB.

Present micro-via technology is now limiting the continued miniaturization of current designs and increasing the need to have passive components placed effectively for optimum signal function. Industry constraints for micro-via size, pad and line width constraints limit the effective use of the outer-layer surfaces. Additional complications during assembly involve issues regarding fine pitch technology and successful attachment of the devices. Use of “build-up” technology is deficient, in part, due to solder sphere issues and material mismatch. Latent defects using build-up technologies may result from high resistance opens (ghost opens) at the inner-connect zone due to disparities in the coefficients of thermal expansion, signal integrity issues and the need for close proximity of passive devices to other components in the network. Also, circuit line and space width restrictions on the outer layers of the PCB, mechanical drill diameters, and micro-via sizes limit the continued shrinking demands for component device pitch widths of 0.5 millimeters and smaller.

There is a continuing demand to reduce the size of micro-vias to 3 mils (75 microns) and beyond. However, there are difficult plating issues inherent with reducing these sizes in the current build-up processes being used. As a result, many OEM's have adopted an intermediate high density interconnect to compensate in the ultimate assembly of the system card. For example, Multi-Chip Modules have been utilized. This can be an expensive and redundant level of packaging that increases cost and degrades electrical performance.

An example of the use of micro-vias is disclosed in U.S. Pat. No. 6,290,860, issued to B. K. Applet et al. This patent discloses a build up technology utilizing permanent photoimageable dielectric material for fabrication of micro-vias both by laser ablation, plasma ablation or mechanical drilling techniques and by photoimaging techniques.

U.S. Pat. No. 5,863,446, issued to D. A. Hanson, discloses a method for determining a fiducial misregistration of conductive layers of a laminated substrate by providing a plurality of alternatingly disposed dielectric layers and conductive layers.

U.S. Pat. No. 6,039,889, issued to L. Zhang et al, discloses processes for forming conductive vias between circuit elements formed on either side of a flexible substrate. In one embodiment, the inventive process starts with a flexible film polyamide substrate one each side of which is arranged a layer of copper.

U.S. Pat. No. 6,280,641, issued to M. Gaku et al, discloses a printed wiring board having micro-via holes for conduction and a method of making the micro-via hole. The process includes providing a coating or sheet of an organic substance containing 3 to 97%, by volume, of at least one selected from a metal compound powder, a carbon powder or a metal powder having a melting point of at least 900° C. and a bond energy of at least 300 kJ/mol on a copper foil as an outermost layer of a copper-clad laminate having at least two copper layers, or providing a coating or sheet of the same after oxidizing a copper foil as an outermost layer. The coating, or sheet, is irradiated with a carbon dioxide gas laser at an output of 20 to 60 mJ/pulse.

All of the aforementioned references disclose micro-via buildup sequences.

### SUMMARY

In a broad aspect, the present invention is a precursor component structure (and a method for forming the precursor component) for a printed circuit board (PCB). The precursor component structure includes a primary composite sheet having a primary upper foil sheet, a primary lower foil sheet and a primary dielectric sheet located therebetween. The primary composite sheet has a desired material set. The primary upper foil sheet is for ultimate use as an external layer of the PCB. The primary lower foil sheet has a primary micro-via hole formed therein that extends through the primary dielectric sheet to a lower surface of the primary upper foil. A primary electrically conductive layer is formed over surfaces of the primary dielectric sheet defining the primary micro-via hole. Thus, a primary electrically conductive path is formed from the primary upper foil sheet to the primary lower foil sheet using these “inverted micro-vias”.

In typical applications, this precursor component structure is augmented by additional inverted micro-vias that are provided by this “building-in” methodology. This provides the basis for incorporating desired resistive and capacitive devices.

The present invention mitigates many industry deficiencies. The desire to decrease integrated circuit component sizes and the ever-increasing demand for higher numbers of I/O devices and their commensurate interconnects has exceeded the design and manufacturing capability of the PCB industry. Furthermore, increasingly fast microprocessors cause coupling, crosstalk, EMI and signal integrity dilemmas in today's PCB designs. These dilemmas are often the problem for the interconnect and functional operation of the assembled PCB. Many interstitial platforms are made as intermediate devices that contain the passive elements for enabling the signal function throughout the assembled PCB. As will be described below, the needed materials and the appropriate controls can be applied to the manufacture of the PCB itself for the ultimate solution and provide improved routing densities for effective IC to PCB modeling and design.

Other objects, advantages, and novel features will become apparent from the following detailed description of the invention when considered in conjunction with the accompanying drawings.

### BRIEF DESCRIPTION OF THE DRAWINGS

FIG. 1 is cross-sectional view of the formation of the primary micro-via hole in a primary composite, in an initial step in the method of forming a precursor component structure for a PCB in accordance with the principles of the present invention.

FIG. 2 is a cross-sectional view of the next step in the method of the present invention in which a primary electrically conductive layer is formed to provide a primary electrically conductive path.

FIG. 3 illustrates the addition of a secondary dielectric sheet and secondary foil sheet in the initial stages of forming additional layer sets to the precursor component of FIG. 1.

FIG. 4 illustrates the formation of a secondary micro-via hole that extends through the secondary composite sheet and through the primary composite sheet.

FIG. 5 illustrates the forming of a secondary electrically conductive layer.

FIG. 6 shows an example of a PCB having core layers and a precursor component structure combination, the PCB also including embedded passive elements and outer land formations.

The same parts or elements throughout the drawings are designated by the same reference characters.

### DETAILED DESCRIPTION OF THE INVENTION

Referring now to the drawings and the characters of reference marked thereon, FIG. 1 illustrates a first step in the formation of a precursor component structure of the present invention. A primary composite sheet, designated generally as 10, is provided including a primary upper foil sheet 12, a primary lower foil sheet 14 and a primary dielectric sheet 16 located therebetween. The primary composite sheet has a desired material set based on the design of the components and the function thereof. For example, digital signals, RF signals, analog, and microwave frequencies require different controls for signal integrity with tight controls for impedance and coupling of resistive and capacitive technology. The primary upper foil sheet 12 will ultimately be used as an external layer of the PCB, as will be described below in detail.

The primary upper and lower foil sheets are typically formed of copper or copper in combination with nickel alloys. Alternatively, these sheets may include copper with polymer additions that function as resistive materials. Suitable foil material is commercially available by, for example, Gould Electronics Inc., and marketed under the trademark TCR™. TCR™ foil is a copper foil with integrated thin film resistors. The foil sheets have a typical thickness in a range of about 12 to about 35 microns.

The dielectric sheet 16 may be, for example, a thin polyimide film such as that marketed by Gould Electronics, Inc. under the trademark TCC™. Another possible sheet 16 could be, for example, Thermount™ dielectric marketed by DuPont Electronics, Inc.

A primary micro-via hole 18 is formed in the primary lower foil sheet. The hole 18 extends through the primary dielectric sheet to a lower surface 20 of the primary upper foil. This inverted micro-via can have a diameter consistent with the present industry standard of about 152 microns (6 mil). In the desire for increased miniaturization, the drive is to decrease micro-via diameters to 75 microns (3 mil). This desire is impeded by present electroplating technologies due to plating aspect ratios. The present invention, as will be explained below, alleviates this need.

The primary micro-via hole 18 may be formed by conventional techniques, such as 1) U.V. laser ablation or 2) etching a window in the copper sheet, followed by ablating the dielectric by plasma or CO₂ laser.

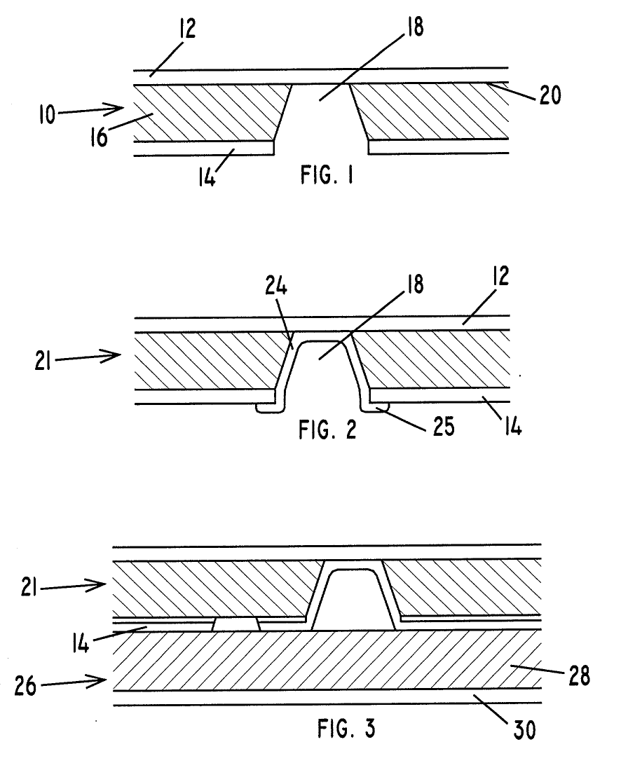

Referring now to FIG. 2, a primary electrically conductive layer 24 is formed over the surfaces of the primary dielectric sheet 16 that define the primary micro-via hole 18. Thus, a primary electrically conductive path is formed from the primary upper foil sheet 12 to the primary lower foil sheet 14. The primary electrically conductive layer may be formed, for example, by chemically applying a seed layer of electrolysis copper. Alternate processes may include, for example, applying a seed layer by direct metallization using graphite, palladium or other elements. Then a copper layer is electroplated to a desired thickness. The primary electrically conductive layer 24 extends onto a lower surface of the primary lower foil sheet 14 to form a primary electrically conductive interconnect 25.

A resulting precursor component structure, designated generally as 21, is thus formed. This precursor component structure 21 includes the primary composite sheet 10 having the primary micro-via hole 18 formed therein; and, the primary electrically conductive layer 24, which forms the primary electrically conductive path.

This precursor component structure 21 is preferably, in a typical application, augmented by additional micro-vias, as will be discussed below. Referring now to FIG. 3, a secondary composite sheet, designated generally as 26, is attached to the primary lower foil sheet 14. The secondary composite sheet 26 includes a secondary dielectric sheet 28 and a secondary lower foil sheet 30 attached thereto. The secondary dielectric sheet 28 is attached to the primary electrically conductive interconnect 25.

Referring now to FIG. 4, a secondary micro-via hole 32 is formed. The secondary microvia hole 32 extends through the secondary dielectric sheet 28, through the primary electrically conductive interconnect 25, through the primary lower foil sheet 14 and through the primary dielectric sheet 16 to a lower surface of the primary upper foil sheet 12.

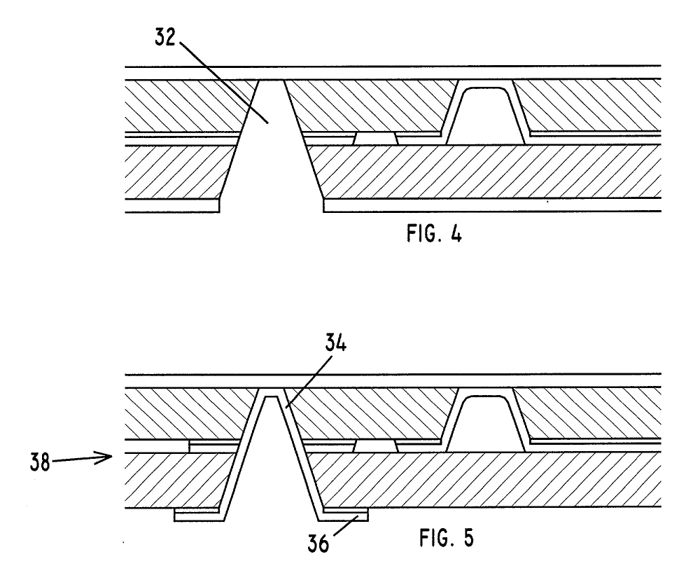

Referring now to FIG. 5, a secondary electrically conductive layer 34 is formed over surfaces of the secondary dielectric sheet 28 and the primary dielectric sheet 16 defining the secondary micro-via hole 32. Thus, a secondary electrically conductive path is formed from the primary upper foil sheet 12 to the secondary lower foil sheet 30. This conductive layer extends to a lower surface of the secondary lower foil sheet 30 to form a secondary electrically conductive interconnect 36. Thus, an augmented precursor component structure, designated generally as 38 is formed.

This “building-in” method, discussed above, in which inverted micro-vias are formed, may be repeated providing additional layers, as desired. Although not discussed above, typical etching procedures of base sheet foils is provided in the appropriate steps discussed above, as is understood by those skilled in the art.

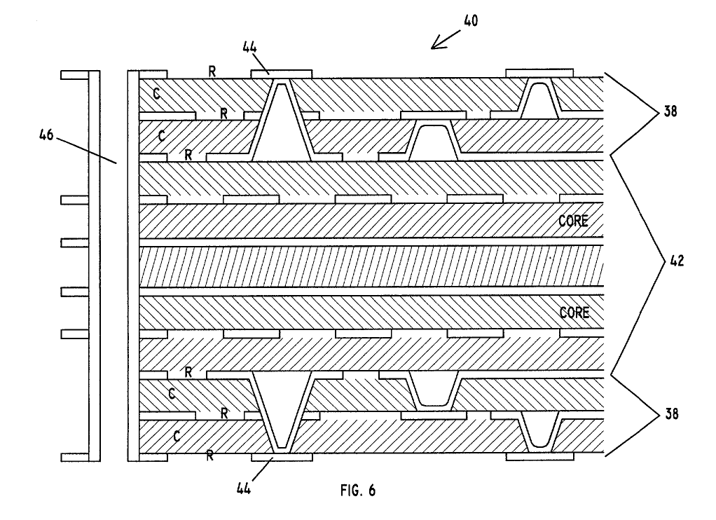

Referring now to FIG. 6, implementation of the process of the present invention to form a completed, interconnected PCB design, designed generally as 40, is illustrated. In this example, a core structure 42 comprising a plurality of cores is combined with precursor component structures 38. Additionally, final plated lands 44 and a conventional through hole via 46 are shown.

As shown in FIG. 6, customer designs and component design layouts can indicate, as shown by letter designations “R” and “C”, that resistive devices (both internal and external) and capacitive dielectrics can be incorporated. Desired configurations may include, for example, appropriate signal, ground, power layers and mixtures thereof. The resistive devices may, for example, be formed of thick film materials.

The present invention facilitates the integration of integrated circuit technology with PCB fabrication techniques. It provides flat pads of solder connections. In addition to minimizing defects in assembly other advantages include combining the desired materials to effectively integrate function and signal speed for reduced cost in assembly. The needed materials and the appropriate controls can be easily provided. Furthermore, resistive and capacitive coupling can be changed for each design.

Obviously, many modifications and variations of the present invention are possible in light of the above teachings. It is, therefore, to be understood that within the scope of the appended claims, the invention may be practiced otherwise than as specifically described.

What is claimed and desired to be secured by Letters Patent of the United States is:

1. A method for forming a precursor component structure for application during final lamination of a printed circuit board (PCB), comprising the steps of:
a) providing a primary composite sheet comprising a primary upper foil sheet, a primary lower foil sheet and a primary dielectric sheet located therebetween, said primary composite sheet having a desired material set, said primary upper foil sheet for ultimate use as an external layer of the PCB;
b) forming a primary micro-via hole in said primary lower foil sheet that extends through said primary dielectric sheet to a lower surface of said primary upper foil; and,
c) forming a primary electrically conductive layer over surfaces of said primary dielectric sheet defining said primary micro-via hole, thus forming a primary electrically conductive path from said primary upper foil sheet to said primary lower foil sheet.

2. The method of claim 1, wherein said step of forming a primary electrically conductive layer comprises forming said primary electrically conductive layer to extend onto a lower surface of said primary lower foil sheet to form a primary electrically conductive interconnect.

3. The method of claim 2, further comprising the step of attaching a secondary composite sheet to said primary lower foil sheet, said secondary composite sheet comprising a secondary dielectric sheet and a secondary lower foil sheet attached thereto, said secondary dielectric sheet being attached to said primary electrically conductive interconnect.

4. The method of claim 3, further comprising forming a secondary micro-via hole, said secondary micro-via hole extending through said secondary dielectric sheet, through said primary electrically conductive interconnect, through said lower foil sheet and through said primary dielectric sheet to a lower surface of said primary upper foil.

5. The method of claim 4, wherein said step of forming a secondary micro-via hole comprises forming a secondary electrically conductive layer over surfaces of said secondary dielectric sheet and said primary dielectric sheet defining said secondary micro-via hole, thus forming a secondary electrically conductive path from said primary upper foil sheet to said secondary lower foil sheet.

6. The method of claim 5, wherein said step of forming a secondary electrically conductive layer comprises forming said secondary electrically conductive layer to extend onto a lower surface of said secondary lower foil sheet to form a secondary electrically conductive interconnect.

7. The method of claim 5, further comprising the steps of forming a plurality of additional micro-via holes, additional dielectric sheets, and additional foil sheets.

8. The method of claim 1, wherein said step of providing a primary composite sheet comprises providing a primary dielectric sheet formed of capacitive material.

9. The method of claim 1, wherein said step of providing a primary composite sheet comprises providing a primary lower foil sheet formed of resistive material.

10. The method of claim 1, wherein said step of providing a primary composite sheet comprises providing a primary upper foil sheet formed of resistive material.

11. The method of claim 3, wherein said step of attaching a secondary composite sheet comprises attaching a secondary dielectric sheet formed of capacitive material.

12. The method of claim 3, wherein said step of attaching a secondary composite sheet comprises attaching a secondary lower foil sheet formed of resistive material.

13. The method of claim 3, wherein said step of attaching a secondary composite sheet comprises attaching a secondary upper foil sheet formed of resistive material.

14. The method of claim 7, wherein said steps of providing a plurality of additional dielectric sheets comprises providing additional dielectric sheets formed of capacitive materials.

15. The method of claim 7, wherein said steps of providing a plurality of additional foil sheets comprises providing additional foil sheets formed of resistive materials.

16. The method of claim 1, wherein said primary electrically conductive layer is formed by chemically applying a seed layer electrolysis copper and then electroplating a copper layer to a desired thickness.

17. The method of claim 15 wherein said resistive materials are formed of thick film materials.

18. A precursor component structure for a printed circuit board (PCB), comprising:
a) a primary composite sheet comprising a primary upper foil sheet, a primary lower foil sheet and a primary dielectric sheet located therebetween, said primary composite sheet having a desired material set, said primary upper foil sheet for ultimate use as an external layer of the PCB, said primary lower foil sheet having a primary micro-via hole formed therein that extends through said primary dielectric sheet to a lower surface of said primary upper foil; and,
b) a primary electrically conductive layer formed over surfaces of said primary dielectric sheet defining said primary micro-via hole, wherein a primary electrically conductive path is formed from said primary upper foil sheet to said primary lower foil sheet.

19. The precursor component structure of claim 18, wherein said primary electrically conductive layer extends onto a lower surface of said primary lower foil sheet to form a primary electrically conductive interconnect.

20. The precursor component structure of claim 19, further comprising a secondary composite sheet attached to said primary lower foil sheet, said secondary composite sheet comprising a secondary dielectric sheet and a secondary lower foil sheet attached thereto, said secondary dielectric sheet being attached to said primary electrically conductive interconnect.

21. The precursor component structure of claim 20, further comprising a secondary micro-via hole extending through said secondary dielectric sheet, through said primary electrically conductive interconnect, through said lower foil sheet and through said primary dielectric sheet to a lower surface of said primary upper foil.

22. The precursor component structure of claim 21, further comprising a secondary electrically conductive layer formed over surfaces of said secondary dielectric sheet and said primary dielectric sheet defining said secondary micro-via hole, thus forming a secondary electrically conductive path from said primary upper foil sheet to said secondary lower foil sheet.

23. The precursor component structure of claim 22, wherein said secondary electrically conductive layer extends onto a lower surface of said secondary lower foil sheet to form a secondary electrically conductive interconnect.

24. The precursor component structure of claim 22, further comprising a plurality of additional micro-via holes, additional dielectric sheets, and additional foil sheets.

25. The precursor component structure of claim 18, wherein said primary composite sheet comprises a primary dielectric sheet formed of capacitive material.

26. The precursor component structure of claim 18, wherein said primary composite sheet comprises a primary lower foil sheet formed of resistive material.

27. The precursor component structure of claim 18, wherein said primary composite sheet comprises a primary upper foil sheet formed of resistive material.

28. The precursor component structure of claim 18, wherein said secondary composite sheet comprises a secondary dielectric sheet formed of capacitive material.

29. The precursor component structure of claim 18, wherein said secondary composite sheet comprises a secondary lower foil sheet formed of resistive material.

30. The precursor component structure of claim 18, wherein said secondary composite sheet comprises a secondary upper foil sheet formed of resistive material.

31. The precursor component structure of claim 24, wherein said plurality of additional dielectric sheets comprises additional dielectric sheets formed of capacitive materials.

32. The precursor component structure of claim 24, wherein said plurality of additional foil sheets comprises additional foil sheets formed of resistive materials.

33. The precursor component structure of claim 24, wherein said primary electrically conductive layer is formed of a chemically applied seed layer electrolysis copper and an electroplated copper layer of a desired thickness.

34. The precursor component structure of claim 32 wherein said resistive materials are formed of thick film materials.

35. A printed circuit board (PCB), comprising:
a) a core structure; and,
b) at least one precursor component structure attached to said core structure, said at least one precursor component structure, comprising:
i) a primary composite sheet comprising a primary upper foil sheet, a primary lower foil sheet and a primary dielectric sheet located therebetween, said primary composite sheet having a desired material set, said primary upper foil sheet for ultimate use as an external layer of the PCB, said primary lower foil sheet having a primary micro-via hole formed therein that extends through said primary dielectric sheet to a lower surface of said primary upper foil; and,
ii) a primary electrically conductive layer formed over surfaces of said primary dielectric sheet defining said primary micro-via hole, wherein a primary electrically conductive path is formed from said primary upper foil sheet to said primary lower foil sheet.

36. The PCB of claim 35, wherein said at least one precursor component structure comprises a plurality of precursor component structures.
